(19) United States
(12) Patent Application Publication
(10) Pub. No.: US 2006/0039034 A1
(43) Pub. Date: Feb. 23, 2006

(54) Photo-direct printer

(75) Inventor: Hiroshi Iwatani, Osaka (JP)

Correspondence Address: CROWELL & MORING LLP;INTELLECTUAL PROPERTY GROUP, P.O. BOX 14300, WASHINGTON, DC, 20044-4300, US

(73) Assignees: Funai Electric Co., Ltd., Daito-shi (JP); Lexmark International, Inc., Lexington, KY (US)

(21) Appl. No.: 11/204,078

(22) Filed: Aug. 16, 2005

(30) Foreign Application Priority Data
Aug. 17, 2004 (JP) 2004-237711

(51) Int. Cl. G06K 15/00

(52) U.S. Cl. 358/1.18

(57) ABSTRACT

A photo-direct printer connected to a digital still camera and comprising a display unit for displaying print layout information created on the basis of multiple divided images sent from the digital still camera. When a user inputs a command to change the print layout information for divided printing, the photo-direct printer changes the print layout information according to content of the command, and performs the divided printing on the basis of the changed print layout information. Since the photo-direct printer has the display unit, it enables the user to identify, at the time of divided printing, a print layout on the printer side. Further, since it is possible to readily change the print layout information, it is possible to readily obtain a result of printing according to the intention of the user.

### BACKGROUND OF THE INVENTION

1. Field of the Invention

The present invention relates to a photo-direct printer that directly receives and prints a digital still image from a digital still camera.

2. Description of the Related Art

Recently, a direct print system has been widespread which directly sends, to a photo-direct printer (hereafter referred to as PD printer), and prints a digital still image from a digital still camera (hereafter referred to as DSC). In the direct print system, there is a standard called PictBridge, which enables a direct print from a DSC to a PD printer even if the DSC and the PD printer are made by different manufacturers.

This PictBridge enables a divided printing (layout print), which prints multiple divided images on one paper, but does not specify a layout mode for the respective divided images in the divided printing. Accordingly, when a user actually performs a divided printing in the PictBridge standard, the divided printing may be done in a print layout different from that the user intends, in some cases, depending on the kind of PD printer. For example, referring to FIG. 7A, even when a user directs a DSC to print divided images, intending a divided printing in the print layout and order of A, B, C and D as shown in FIG. 7A, the divided printing may be done in a print layout as shown in FIG. 7B, in some cases, depending on the kind of PD printer. In order to prevent such from occurring, it is desirable that at the time of divided printing, a user can identify the then print layout on the PD printer side.

In many cases, a PD printer may merely lay out respective divided images through in an order of a print command sent from a DSC. Accordingly, unless the user directs the DSC to print the respective divided images in an appropriate order according to the layout mode of the respective divided images on the PD printer side, it is not possible to perform a divided printing in the intended print layout. For example, when the user wishes to perform a divided printing in a print layout as shown in FIG. 8, it is necessary that the user directs the DSC to print the respective divided images in the order of D, A, C and B.

Furthermore, the conventional divided printing according to the PictBridge standard has a problem that the layout mode of respective divided images is determined by the PD printer, so that the user cannot align the respective divided images in an optional orientation. For example, even when the user wishes to perform a divided printing in a print layout as shown in FIG. 9A, actually it can only perform a divided printing in a layout as shown in FIG. 9B.

### SUMMARY OF THE INVENTION

An object of the present invention is to provide a photo-direct printer that enables a user to identify a print layout on printer side at the time of divided printing, and further to readily change an arrangement order and/or orientation of respective divided images in the print layout, thereby making it possible to readily obtain a result of printing according to the intention of the user.

According to the present invention, we provide a photo-direct printer connected to a digital still camera, the photo-direct printer comprising: a transmission means for receiving multiple divided images sent from the digital still camera, and for transmitting various commands to and from the digital still camera; a layout creating means for creating print layout information based on the multiple divided images received by the transmission means; a display means for displaying the print layout information created by the layout creating means; a command input means for inputting a command to change the print layout information for printing, on one paper, multiple divided images sent from the digital still camera (such printing being hereafter referred to as divided printing); a layout changing means for changing the print layout information according to content of the command to change the print layout information when the command is input by a user using the command input means; and a printing means for performing the divided printing based on the print layout information changed by the layout changing means.

The photo-direct printer according to the present invention enables a user to identify, at the time of divided printing, a print layout on the printer side, because the photo-direct printer has the display means. Furthermore, when the user inputs a command to change the print layout information for divided printing, the print layout information is changed according to content of the command, and the divided printing is performed on the basis of the changed print layout information. This makes it possible to readily obtain a result of printing according to the intention of the user.

The photo-direct printer can be designed so that for performing the divided printing, the command input means is used to input a command to change an arrangement order of the multiple divided images in the print layout information, and that the layout changing means changes the arrangement order of the multiple divided images in the print layout information according to content of the command to change the arrangement order of the multiple divided images in the print layout information when the command is input by the user using the command input means.

Further, the photo-direct printer can be designed so that for performing the divided printing, the command input means is used to input a command to change an orientation of the multiple divided images in the print layout information, and that the layout changing means changes the orientation of the multiple divided images in the print layout information according to content of the command to change the orientation of the multiple divided images in the print layout information when the command is input by the user using the command input means.

Still further, the photo-direct printer can be designed so that for performing the divided printing, the command input means is used to input a command to change an arrangement order and orientation of the multiple divided images in the print layout information, and that the layout changing means changes the arrangement order and orientation of the multiple divided images in the print layout information according to content of the command to change the arrangement order and orientation of the multiple divided images in the print layout information when the command is input by the user using the command input means.

Preferably, the photo-direct printer further comprises a decoder and an encoder that are able to handle both commands in PTP (Picture Transfer Protocol) format and commands in PictBridge format.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic view of a PD printer according to an embodiment of the present invention, and a DSC connected to the PD printer;

FIG. 2 is an electrical block diagram of the PD printer and the DSC;

FIG. 3 is a communication protocol architecture of PictBridge employed in the direct print system formed by the PD printer and the DSC;

FIG. 4 is a process chart showing a process of identifying and changing a print layout in the PD printer;

FIG. 5 is a chart for explaining a process of changing an orientation of divided images in the process of identifying and changing the print layout;

FIG. 6 is a chart for explaining a process of changing an arrangement order and orientation of divided images in the process of identifying and changing the print layout; and

Each of FIG. 7A, FIG. 7B, FIG. 8, FIG. 9A and FIG. 9B is a chart for explaining a problem in a conventional PD printer at the time of divided printing.

### DESCRIPTION OF THE PREFERRED EMBODIMENTS

The best modes and preferred embodiments of the present invention will be described hereinafter with reference to the annexed drawings. The present invention relates to a photo-direct printer (hereafter referred to as PD printer) that directly receives and prints a digital still image from a digital still camera (hereafter referred to as DSC). Note that the specific embodiments described are not intended to cover the entire scope of the present invention, and hence the present invention is not limited to only the specific embodiments.

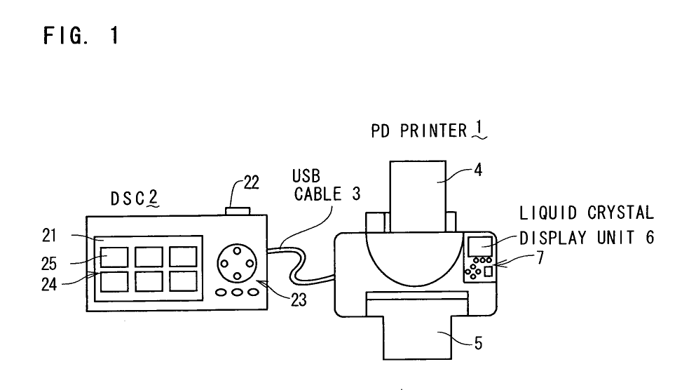

FIG. 1 shows a schematic view of a PD printer 1 according to an embodiment of the present invention, and a DSC 2 connected to the PD printer 1. The PD printer 1 and the DSC 2 are connected to each other via a USB (Universal Serial Bus) cable 3, thereby forming a direct print system. This direct print system uses PictBridge technology to achieve direct print from the DSC 2 to the PD printer 1. Here, PictBridge technology is an industry standard, established by the Camera & Imaging Products Association (CIPA), an organization in Japan, which enables digital images to be printed from a digital camera without using a personal computer, or which enables a direct print from a DSC to a PD printer even if the DSC and the PD printer are made by different manufacturers.

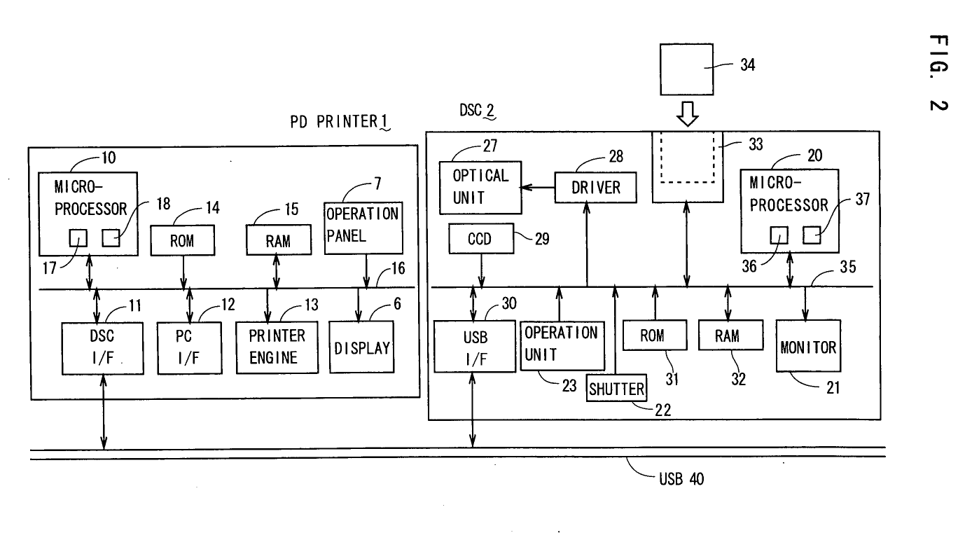

As shown in FIG. 1, the PD printer 1 comprises: a feed tray 4 for loading photo-printing papers; a discharge tray 5 for loading printed papers; a liquid crystal display unit 6 (display means) for displaying print layout information, various messages, and so on; and an operation panel 7 (command input means) for performing various operations. On the other hand, as shown in FIG. 1, the DSC 2 comprises: a liquid crystal monitor 21 and an operation unit 23 for performing various operations, which are provided on the rear side of the DSC 2; and a shutter 22 provided on an upper end of the DSC 2. Displayed on the liquid crystal monitor 21 are: an image of light which is then incident on a CCD (Charge-Coupled Device) 29 (refer to FIG. 2); a photographed digital still images 25 (hereafter referred to as photographed images); and a selection screen 24 for selecting images to be printed in a divided printing, that is printing of multiple divided images on one paper. As shown in FIG. 1, the selection screen 24 is a screen displaying a group of multiple photographed images 25 in thumbnail size.

FIG. 2 shows an electrical block diagram of the PD printer 1 and the DSC 2. The PD printer 1 comprises, in addition to the liquid crystal display unit (display) 6 and the operation panel 7: a microprocessor 10 (serving as a layout creating means as well as a layout changing means) for controlling the entire PD printer 1; a DSC I/F 11 (transmission means) which is an interface circuit for connection to the DSC 2 (namely an interface circuit on the host side of the USB); a PC (Personal Computer) I/F 12 which is an interface circuit for connection to a personal computer; a printer engine 13 (printing means) for printing images received from e.g. the DSC 2; a ROM (Read-Only Memory) 14 for storing font data and a control program describing a procedure of the microprocessor 10; and a RAM (Random Access Memory) 15 for temporarily storing images received from e.g. the DSC 2 and later described print layout information.

Transmission (sending and receiving) of data among these units or elements in the PD printer 1 is done via an internal bus 16 as shown in FIG. 2. The DSC I/F 11 receives multiple divided images sent from the DSC 2, and further transmits (sends and receives) various commands to and from the DSC 2. The microprocessor 10 comprises a decoder 17 and an encoder 18 that are able to handle both commands in PTP (Picture Transfer Protocol) format and commands in PictBridge format.

On the other hand, the DSC 2 comprises, in addition to the liquid crystal monitor 21 (monitor in FIG. 2), shutter 22 and operation unit 23: a microprocessor 20 for controlling the entire DSC 2; an optical unit 27 comprising a lens and its drive system; a driver 28 for controlling the optical unit 27; a CCD (Charge Coupled Device) 29 which is an imaging device; a USB I/F 30 which is an interface circuit for connection to the PD printer 1 (namely an interface circuit on the slave side of the USB); a ROM 31 for storing a control program describing a procedure of the microprocessor 20; a RAM 32 for temporarily storing various data; and a connector 33 for connection to a memory card 34 for recording photographed images. Transmission of data among these units or elements in the DSC 2 is done via an internal bus 35 as shown in FIG. 2. The microprocessor 20 comprises a decoder 36 and an encoder 37 that handle commands in PTP format and commands in PictBridge format.

Transmission of data between the DSC 2 and the PD printer 1 is done via the USB I/F 30, a USB 40 and the DSC I/F 11.

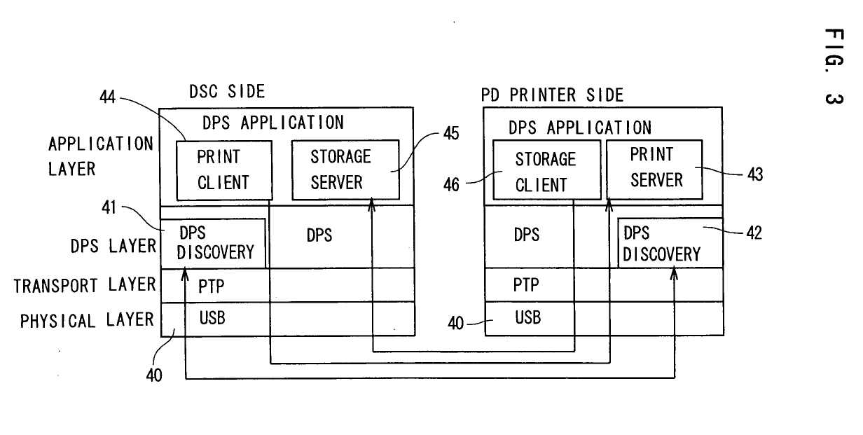

FIG. 3 shows a communication protocol architecture of PictBridge employed in the direct print system. In PictBridge, USB (here USB 40) is used as a physical layer, and PTP is used as a transport layer. Further, as shown in FIG. 3, a DPS (Digital Photo Solution) layer, which is an additional conversion layer, is provided between the transport layer and an application layer. This DPS layer provides a mapping between the communication protocol of PTP and the DPS Application. PictBridge is a technology that standardizes the interface protocol between the DPS layer and the application layer.

Next, referring to FIG. 3, software components of PictBridge will be described. The software components of PictBridge include Print Server 43, Print Client 44, Storage Server 45 and Storage Client 46 existing in the application layer, and further include DPS Discoveries 41 and 42 existing in the DPS layer. In PictBridge, it is assumed that the printer requests the DSC for image data when the printer performs printing in response to a print request from the DSC. Thus, normally, a user does not pay attention to the Storage Client 46. Basically, in the DPS Application, each DPS operation is completed in a sequence that the Server responds to a request from the Client, and then replies with a result of the request back to the Client. Further, each DPS Event is completed in a sequence that the Client responds to a notification issued from the Server, and then replies with a confirmation of the receipt back to the Server.

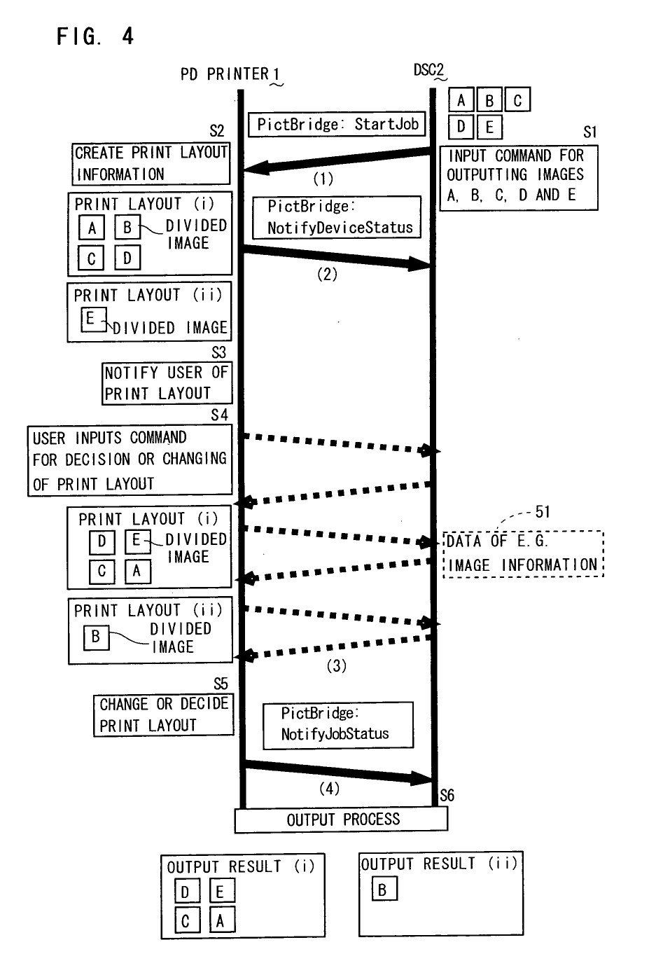

Next, referring to FIG. 4 which is a process chart showing a process of identifying and changing a print layout in the PD printer 1, the function of identifying and changing the print layout in the PD printer 1 will be described. First, the microprocessor 10 of the PD printer 1, as a device, and the microprocessor 20 of the DSC 2, as a further device, identify information about each other device (product information or device information) and recognize the function which the each other device has. More specifically, when the transport layer connection (PTP level connection) between the PD printer 1 and the DSC 2 is established with these devices being connected by the USB cable 3, the microprocessors 10 and 20 perform a negotiation process, using the DPS Discoveries 41 and 42 shown in FIG. 3, to identify whether or not the each other device has a DPS function. If the microprocessors 10 and 20 recognize that the each other device is PictBridge-compatible (namely that the each other device has a DPS function), they perform the following process.

When a user operates the operation unit 23 in the DSC 2 to input a command for divided printing in 4-up layout (that is a layout for printing four divided images on one paper), the microprocessor 20 of the DSC 2 displays a selection screen 24 containing multiple photographed images 25 on the liquid crystal monitor 21 as shown in FIG. 1. In this state, if the user operates the operation unit 23 to select images A, B, C, D and E for divided printing (hereafter referred to simply as divided images) from the photographed images 25 displayed on the selection screen 24 and to input a command for outputting these divided images (S1), the microprocessor 20 creates, using the encoder 37 of the DSC 2, a command (StartJob) in PictBridge format for the divided printing in the 4-up layout. As shown by arrow (1) in FIG. 4, the microprocessor 20 sends the thus created command to the PD printer 1 using the USB I/F 30, and further sends the divided images A, B, C, D and E to the PD printer 1 in the order selected by the user using the operation unit 23.

When the microprocessor 10 of the PD printer 1 receives, from the DSC 2, the command in PictBridge format for the divided printing, the microprocessor 10 decodes the received command using the decoder 17 of the PD printer 1. Then, the microprocessor 10 creates, using the encoder 18, a command (NotifyDeviceStatus) in PictBridge format for notifying that the PD printer 1 is in the print state. As shown by arrow (2) in FIG. 4, the microprocessor 10 sends the thus created command to the DSC 2 using the DSC I/F 11. Subsequently, the microprocessor 10 of the PD printer 1 creates print layout information (i) and (ii) (print layout (i) and (ii)) in which the divided images A, B, C, D and E received from the DSC 2 are arranged in the received order (S2). Further, the microprocessor 10 displays the thus created print layout information (i) and (ii) on the liquid crystal display unit 6 for notification to the user (S3).

When the user operates the operation panel 7: to input a command for performing printing, using the print layout information (i) and (ii) that are then displayed on the liquid crystal display unit 6 (hereafter such command input being sometimes referred to as decision command input); or to input a command for changing the arrangement order and/or orientation of divided images A, B, C, D and E in the print layout information (i) and (ii) that are then displayed on the liquid crystal display unit 6 (hereafter such command input being sometimes referred to as change command input) (S4), the microprocessor 10 of the PD printer 1 performs a process according to the content of the either command input. More specifically, if the content of the command input is to change the arrangement order and/or orientation of divided images A, B, C, D and E, the microprocessor 10 changes the print layout information (i) and (ii) according to the content of the command.

On the other hand, if the content of the command input is to perform printing, using the print layout information (i) and (ii) that are then displayed on the liquid crystal display unit 6, the microprocessor 10 uses, as decided print layout information, the print layout information (i) and (ii) that are created in the above step S2 (S5). Further, based on the print layout information (i) and (ii) that have been changed or decided in the step 5, the microprocessor 10 starts an output process of divided printing (S6). Each time an event such as “printing on n-th paper completed” or “printing ended” occurs, the microprocessor 10 creates, using the encoder 18, a command (NotifyJobStatus) in PictBridge format for indicating a print job state, and sends the thus created command to the DSC 2 as shown by arrow (4) in FIG. 4.

For example, when the user operates the operation panel 7 to input a command for changing the arrangement order of divided images A, B, C, D and E in the print layout information (i) and (ii), that are then displayed on the liquid crystal display unit 6, to an arrangement order of divided images D, E, C, A and B as shown in FIG. 4, the print layout information (i) and (ii) are changed according to the content of this command. Thus, as shown in FIG. 4, an output result (i) and (ii) obtained by the output process in the above step S6 are in accordance with the changed print layout information (i) and (ii).

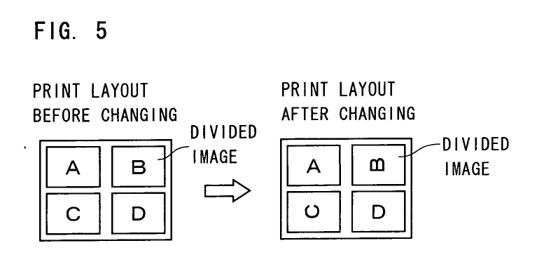

Further, for example, when the user operates the operation unit 23 of the DSC 2 to input a command for changing the orientation of certain ones of divided images A, B, C and D in the print layout information, the print layout information on the PD printer 1 side is changed according to the content of the command as shown in FIG. 5. Thus, the output result obtained by the output process in the above step S6 is in accordance with the changed print layout information.

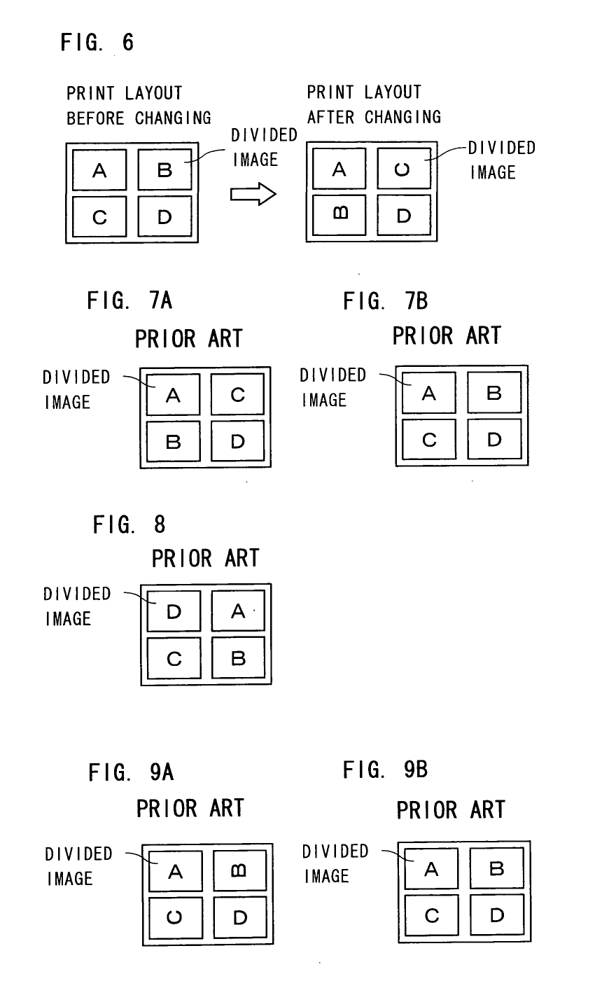

Furthermore, for example, when the user operates the operation unit 23 of the DSC 2 to input a command for changing the arrangement order and orientation of certain ones of divided images A, B, C and D in the print layout information, the print layout information on the PD printer 1 side is changed according to the content of the command as shown in FIG. 6. Thus, the output result obtained by the output process in the above step S6 is in accordance with the changed print layout information.

Note that it can be designed so that at the time of the change command input for changing the print layout information (i) and (ii) shown in the above step S4, the microprocessor 10 of the PD printer 1 fetches, again from the DSC 2, data 51 of e.g. image information contained in image files of divided images A to E as shown by dashed arrow (3) in FIG. 4, using PTP command, in order to create print layout information (i) and (ii) again. More specifically, it can be designed so that if, in the print layout information creation process in the above step S2, the microprocessor 10 of the PD printer 1 creates print layout information (i) and (ii) based on image information (e.g. JPEG 1, JPEG 2, JPEG 3, JPEG 4 or JPEG 5 where JPEG stands for Joint Photographic Experts Group) contained in image files of divided images A to E, then the microprocessor 10 fetches the image information again from the DSC 2 at the time of the change command input, using PTP command (GetObjectlnfo), in order to create print layout information (i) and (ii) again.

Further, it can be designed so that if, in the above print layout information creation process, the microprocessor 10 creates print layout information (i) and (ii) based on thumbnail images contained in the image files of divided images A to E, then the microprocessor 10 fetches the thumbnail images again from the DSC 2 at the time of the change command input, using PTP command (GetThumb), in order to create print layout information (i) and (ii) again. Furthermore, it can be designed so that if, in the above print layout information creation process, the microprocessor 10 creates print layout information (i) and (ii) based on full-scale image data contained in the image files of divided images A to E, then the microprocessor 10 fetches the full-scale image data again from the DSC 2 at the time of the change command input, using PTP command (GetObject), in order to create print layout information (i) and (ii) again. It is to be noted, however, that these processes of fetching, again from the DSC 2, data 51 such as image information, thumbnail images and full-scale image data become unnecessary if the microprocessor 10 of the PD printer 1 stores, in the RAM 15, such data 51 of e.g. the image information of the divided images A to E which received initially from the DSC 2.

It is also to be noted that if, in the print layout information creation process in the above step S2, the microprocessor 10 of the PD printer 1 creates print layout information (i) and (ii) based on the image information or the thumbnail images contained in the image files of the divided images A to E, then it is necessary for the microprocessor 10 to acquire, from the DSC 2, full-scale image data corresponding to the image information or the thumbnail images of the divided images A to E, using PTP command (GetObject) in the output process of divided printing in the above step S6.

As described in the foregoing, the PD printer 1 according to the present embodiment enables a user to identify, at the time of divided printing, a print layout on the printer side, because the PD printer 1 has the liquid crystal display unit 6 for displaying print layout information created on the basis of divided images A to E received from the DSC 2. Furthermore, according to the PD printer 1, at the time of the change command input by the user for changing an arrangement order and/or orientation of multiple divided images in the print layout information, the microprocessor 10 changes the print layout information according to the content of the command, and performs a divided printing based on the changed print layout information. This makes it possible to readily change the arrangement order and/or orientation of respective divided images in the print layout, thereby readily enabling printing according to the intention of the user.

It is to be noted that the present invention is not limited to the above embodiments, and various modifications are possible. For example, although the above embodiment describes an example for divided printing in 4-up layout, the layer to which the preset invention can be applied is not limited thereto. For example, it can be a 2-up layout or an 8-up layout. Further, although the above embodiment describes an example in which the PD printer 1 and the DSC 2 are connected to each other via the USB cable 3, the kind of cable for connecting the PD printer 1 and the DSC 2 is not limited thereto. Furthermore, although the above embodiment describes an example in which the direct print from the DSC 2 to the PD printer 1 is achieved by using PictBridge, other protocol can be used as well for the direct print.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-237711 filed Aug. 17, 2004, the contents of which are hereby incorporated by reference.

What is claimed is:

1. A photo-direct printer connected to a digital still camera, the photo-direct printer comprising:
a transmission means for receiving multiple divided images sent from the digital still camera, and for transmitting various commands to and from the digital still camera;
a layout creating means for creating print layout information based on the multiple divided images received by the transmission means;
a display means for displaying the print layout information created by the layout creating means;
a command input means for inputting a command to change the print layout information for printing, on one paper, multiple divided images sent from the digital still camera (such printing being hereafter referred to as divided printing);
a layout changing means for changing the print layout information according to content of the command to change the print layout information when the command is input by a user using the command input means; and
a printing means for performing the divided printing based on the print layout information changed by the layout changing means.

2. The photo-direct printer according to claim 1,
wherein for performing the divided printing, the command input means is used to input a command to change an arrangement order of the multiple divided images in the print layout information, and
wherein the layout changing means changes the arrangement order of the multiple divided images in the print layout information according to content of the command to change the arrangement order of the multiple divided images in the print layout information when the command is input by the user using the command input means.

3. The photo-direct printer according to claim 2,
wherein the photo-direct printer is connected to the digital still camera via USB (Universal Serial Bus).

4. The photo-direct printer according to claim 2,
which further comprises a decoder and an encoder that are able to handle both commands in PTP (Picture Transfer Protocol) format and commands in PictBridge format.

5. The photo-direct printer according to claim 1,
wherein for performing the divided printing, the command input means is used to input a command to change an orientation of the multiple divided images in the print layout information, and
wherein the layout changing means changes the orientation of the multiple divided images in the print layout information according to content of the command to change the orientation of the multiple divided images in the print layout information when the command is input by the user using the command input means.

6. The photo-direct printer according to claim 5,
wherein the photo-direct printer is connected to the digital still camera via USB (Universal Serial Bus).

7. The photo-direct printer according to claim 5,
which further comprises a decoder and an encoder that are able to handle both commands in PTP (Picture Transfer Protocol) format and commands in PictBridge format.

8. The photo-direct printer according to claim 1,
wherein for performing the divided printing, the command input means is used to input a command to change an arrangement order and orientation of the multiple divided images in the print layout information, and
wherein the layout changing means changes the arrangement order and orientation of the multiple divided images in the print layout information according to content of the command to change the arrangement order and orientation of the multiple divided images in the print layout information when the command is input by the user using the command input means.

9. The photo-direct printer according to claim 8,
wherein the photo-direct printer is connected to the digital still camera via USB (Universal Serial Bus).

10. The photo-direct printer according to claim 8,
which further comprises a decoder and an encoder that are able to handle both commands in PTP (Picture Transfer Protocol) format and commands in PictBridge format.

11. The photo-direct printer according to claim 1,
wherein the photo-direct printer is connected to the digital still camera via USB (Universal Serial Bus).

12. The photo-direct printer according to claim 1,
which further comprises a decoder and an encoder that are able to handle both commands in PTP (Picture Transfer Protocol) format and commands in PictBridge format.
